(19) United States
(12) Patent Application Publication
(10) Pub. No.: US 2007/0080521 A1
(43) Pub. Date: Apr. 12, 2007

(54) Motor vehicle part including an airbag safety device, and a method of assembling such a part

(75) Inventors: Dominique Leserre, Montry (FR); Didier Ponthieu, La Neuville Saint Pierre (FR)

Correspondence Address: YOUNG & THOMPSON, 745 SOUTH 23RD STREET, 2ND FLOOR, ARLINGTON, VA, 22202, US

(73) Assignee: FAURECIA INTERIEUR INDUSTRIE, NANTERRE (FR)

(21) Appl. No.: 10/580,240

(22) PCT Filed: Nov. 29, 2004
(86) PCT No.: PCT/FR04/03059

§ 371 Date: May 22, 2006

(30) Foreign Application Priority Data
Dec. 15, 2003 (FR) 0314676
Jul. 9, 2004 (FR) 0407719
Jul. 13, 2004 (FR) 0407826

(51) Int. Cl. B60R 21/215; B60R 21/205

(52) U.S. Cl. 280/728.3; 280/732

(57) ABSTRACT

A part (1) includes an airbag safety device (21), an instrument board element (3) formed with an extraction flap (13) of the bag, a frame (23) which is fixed to the instrument board element (3) in such a way as to form a channel (65) for guiding the unfolding of the bag, and a shutter (25) for reinforcing the flap (13), a retaining part (93) of the shutter being connected to the frame (23) by at least one retaining hook (95). The hook (95) is formed from one piece with the shutter (25), and co-operates with a complementary shoulder (87A) formed with the frame (23) when the device is triggered. The invention also relates to a method for assembling one such part (1).

A first aspect of the present invention relates to a motor vehicle part comprising:
an airbag safety device comprising a housing and an airbag contained in said housing;
a dashboard portion formed with an extraction hatch adapted to open under the effect of the airbag inflating when the device is triggered;
a frame secured to the dashboard portion; and
a flap for reinforcing the hatch, a portion of the flap being pressed against a face of the hatch and being secured thereto, and in which a retaining portion is secured to the frame via at least one retaining hook acting against the flap being ejected in the event of the device being triggered.

An arrangement is known in the prior art, in particular from document EP 1 302 373, in which the portions for retaining the reinforcing flap are connected to the frame by means of hooks. The hooks are secured to the housing of the safety device (or airbag module), and they are engaged in corresponding orifices firstly in the frame and secondly in the flap-reinforcing portion.

Such an arrangement is not entirely satisfactory because firstly it requires fastenings to exist between the frame and the airbag module housing, and also it requires the same position for the connections between the flap and the frame, and also for the connections between the housing and the frame. That arrangement thus presents difficulties in being adapted to dashboards of various configurations.

In addition, that arrangement makes assembling the part complex, since it requires the flap-retaining portions to be positioned accurately and to be held in position on the frame prior to putting the airbag module into place.

In other prior art arrangements, that are in more widespread use, the reinforcing flap is connected to the frame by screw fastening or by riveting. That technique is not satisfactory insofar as fastening the flap to the frame involves using additional fasteners, and thus involves additional mounting time.

An object of the invention is to remedy the above-specified drawbacks.

According to the invention, this object is achieved by the fact that the hook is formed integrally with the flap and, during triggering of the device, co-operates with a complementary shoulder formed with the frame.

According to other characteristics of the invention that are optional:

said shoulder is defined by a window formed in the frame, and the dashboard portion presents at least one rib that projects into the window so as to close the window at least in part and hold the hook engaged in said window;
the hook is T-shaped, the window being of corresponding shape;
the frame presents a rim for fastening to the dashboard portion, the rim having both a face pressed against and secured to a complementary face of the dashboard portion, and also an adjacent wall that is substantially orthogonal thereto, and each window comprises a respective insertion portion for inserting the hook formed in said rim, and a retaining portion forming a shoulder for the hook that is formed in said adjacent wall, the insertion portion being closed at least in part by the respective ribs of the dashboard portion;
the flap comprises a plate of shape complementary to the hatch and secured thereto, and the retaining portion comprises at least one strip formed integrally with said plate from an edge thereof, with said hook being formed beside the free end of said strip;
the strip presents an undulation such that said strip can be stretched, thus enabling the hatch to become completely detached and to be ejected from the dashboard portion on triggering of the device; and
the flap has at least two such strips disposed symmetrically from an edge of the plate, and each formed with a hook.
The invention also provides a method of assembling a part as described above, in which method, the following operations are performed in succession:
fixing the flap to the corresponding face of the hatch;
presenting the frame for fastening to the dashboard portion, and engaging the hooks in the respective windows; and
fastening the frame to the dashboard portion.

According to other characteristics of the method of the invention that are optional:
the safety device is subsequently fastened relative to the frame;
the flap is fastened to the hatch by heat-sealing; and
the frame is fastened to the dashboard portion by heat-sealing.

In a second aspect, the invention provides a motor vehicle dashboard assembly comprising:
a dashboard portion having an inside face provided with a peripheral line of weakness defining a gate zone;
a guide element for guiding deployment of the airbag of an airbag safety device, said guide element being secured to the inside face of the dashboard portion and comprising:
   walls forming a guide channel designed to surround the airbag safety device at least in part; and
   a peripheral rim for fastening the guide element to the inside face of the dashboard portion around the gate zone, and internally defining an opening zone of the dashboard portion for passing the airbag;
at least one reinforcing flap secured to the inside face of the dashboard portion in register with the gate zone; and
a hinge element connecting the reinforcing flap to the guide element and/or to the dashboard portion.

Such a dashboard assembly operates on the following principles.

During deployment of the airbag, the guide channel concentrates the pressure forces developed by inflating the airbag and acting through the airbag on the reinforcing flap and on the gate zone.

The line of weakness breaks, thereby separating the perimeter of the gate zone from the remainder of the dashboard portion.

Still under the action of pressure forces developed by the airbag inflating, the gate zone and the associated reinforcing flap disengage the opening zone in the dashboard portion for passing the airbag, firstly by deployment of the hinge element and secondly, sequentially and/or simultaneously, by the gate zone and the associated reinforcing flap pivoting about an axis forming part of the hinge element.

EP-A-0 970 856 and FR-A-2 776 974 disclose motor vehicle dashboard assemblies of the above-described type.

However, in those documents, the hinge element is disposed in the guide channel. As a result, during deployment of the airbag, the airbag interferes with the hinge element, thereby altering the deployment dynamics of the hinge element and the pivoting dynamics of the gate zone and the associated reinforcing flap, and consequently not deploying the airbag optimally into the cabin.

In addition, the positioning of the hinge element in the guide channel limits any possibility of optimizing the length or the shape of the hinge element because of this interference on deployment.

Thus, prior art motor vehicle dashboard assemblies present a risk of spoiling optimum deployment of the airbag and/or of limiting freedom in designing the hinge element in order to optimize deployment of the airbag.

An object of the present invention is to solve that problem by reducing the risks of poor deployment of the airbag and by leaving freedom to design the hinge element in order to optimize deployment of the airbag.

To this end, the invention relates to a motor vehicle dashboard assembly comprising:
a dashboard portion having an inside face and a gate zone provided with a peripheral line of weakness;
a guide element for guiding deployment of the airbag of an airbag safety device, said guide element being secured to the inside face and comprising:
   walls forming a guide channel for surrounding the airbag safety device at least in part; and
   a peripheral rim for fastening to the inside face of the dashboard portion around the gate zone, and internally defining an opening zone in the dashboard portion for passing the airbag;
at least one reinforcing flap secured to the inside face of the dashboard portion in register with the gate zone; and
a hinge element connecting the reinforcing flap to the guide element.

According to the invention, the guide element includes a hinge shield isolating the hinge element from the guide channel.

In this way, the hinge can deploy and enable the gate zone and the associated reinforcing flap to pivot without being disturbed by interference with the airbag while it deploys.

In addition, since the hinge no longer interferes with the deploying airbag, designers of the hinge element have greater freedom concerning the dimensional parameters and/or the shape of the hinge element.

According to another characteristic of the invention, the walls forming the guide channel are made together with the peripheral fastening rim by injection-molding plastics material.

According to another characteristic of the invention, the wall of the guide element facing the hinge element presents a double wall forming a cavity surrounding said hinge element, the double wall having a shield-forming first wall that provides continuity for the guide channel as far as the reinforcing flap, and a second wall that is connected to the peripheral fastening rim.

According to another characteristic of the invention, the hinge element is made together with the reinforcing flap by molding.

In an embodiment, the hinge element presents an operative fastening zone opposite from the reinforcing flap, said operative fastening zone being assembled to the peripheral fastening rim of the guide element and/or to the dashboard portion.

In a third aspect, the invention relates to a motor vehicle part comprising:
a dashboard portion formed with an extraction hatch adapted to open under the effect of inflation of the airbag of an airbag safety device, in the event of the device triggering;
a frame secured to the dashboard portion, and forming a guide channel for guiding the deployment of the airbag; and
a reinforcing flap for reinforcing the hatch, having a reinforcing plate pressed against a face of the hatch and secured thereto, and having a hinge element connected to the frame and/or to the dashboard portion via at least one operative assembly zone acting against ejection of the flap during triggering of the device.

An arrangement is known in the prior art, in particular from document EP 1 302 373, in which the portions for retaining the reinforcing flap are connected to the frame by means of hooks. The hooks are secured to the housing of the safety device (or airbag module), and they are engaged in corresponding orifices firstly in the frame and secondly in the flap-reinforcing portion.

Such an arrangement is not entirely satisfactory because firstly it requires fastenings to exist between the frame and the airbag module housing, and also it requires the same position for the connections between the flap and the frame, and also for the connections between the housing and the frame. That arrangement thus presents difficulties in being adapted to dashboards of various configurations.

In addition, that arrangement makes assembling the part complex since it requires the flap-retaining portions to be positioned accurately and to be held in position on the frame prior to putting the airbag module into place.

In other prior art arrangements, that are in more widespread use, the reinforcing flap is connected to the frame by screw fastening or by riveting. That technique is not satisfactory insofar as fastening the flap to the frame involves using additional fasteners, and thus involves additional mounting time.

An object of the invention is to remedy the above-specified drawbacks.

This object is achieved in the invention by the fact that the hinge element is made integrally with the flap and, on triggering of the device, co-operates with at least one complementary shoulder formed with the frame or with the dashboard portion.

In an embodiment of the invention, the shoulder is defined by a rib formed projecting from the frame or from the dashboard portion, and the operative assembly zone of the hinge element is provided with at least one opening through which the rib passes, the rib presenting a free end coming into contact respectively with the dashboard portion or the frame so as to hold the rib engaged in the opening of the operative assembly zone at the interface between the frame and the dashboard portion.

The frame presents a rim for fastening to the dashboard portion, the frame having a face pressed against and secured to a complementary face of the dashboard portion, and the ribs are localized in setback zones of the face that is pressed against and secured to the complementary face of the dashboard portion, in such a manner that the free ends of the ribs lie in the plane of the face that is pressed against and secured to a complementary face of the dashboard portion.

In another embodiment of the invention, the shoulder is defined by a passage formed through the frame, and the operative assembly zone of the hinge element is provided with at least one catch directed away from the dashboard portion and passing through the passage.

The frame presents a rim for fastening to the dashboard portion, the rim having a face pressed against and fastened to a complementary face of the dashboard portion, and the passages are localized in setback zones of the face pressed against and fastened to the complementary face of the dashboard portion in such a manner that the catches are held in position in the passages by the overlying dashboard portion.

According to other characteristics of the invention:
the flap comprises a plate of shape complementary to the hatch and secured thereto, and the hinge element comprises at least one strip made integrally with said plate from an edge thereof, an operative assembly zone being formed beside the free end of said strip;
the strip presents an undulation, such that strip can be stretched, thereby enabling the hatch to become completely detached and to be ejected from the dashboard portion, during triggering of the device; and
the flap includes at least two such strips arranged symmetrically from an edge of the plate, each being formed with a respective operative assembly zone.

The invention also provides a method of assembling a part as described above, in which method the following operations are performed in succession:
fastening the flap to the corresponding face of the hatch;
presenting the frame for fastening to the dashboard portion, and causing the operative zones to co-operate with the respective complementary shoulders; and
fastening the frame to the dashboard portion.

Advantageously, the flap is fastened to the hatch by heat-sealing.

Similarly, the frame is fastened to the dashboard portion by heat-sealing.

Particular embodiments of the invention are described below in detail with reference to the accompanying drawings, in which:

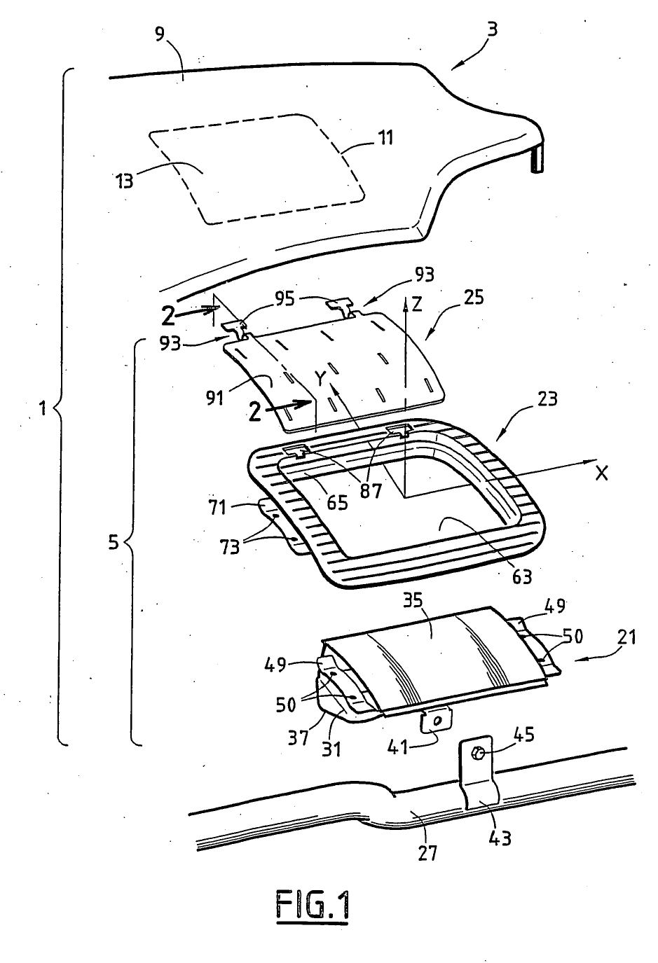

FIG. 1 is a fragmentary exploded perspective view showing an interior part of a motor vehicle in accordance with a first aspect of the invention, are also showing a structural cross-beam of the vehicle;

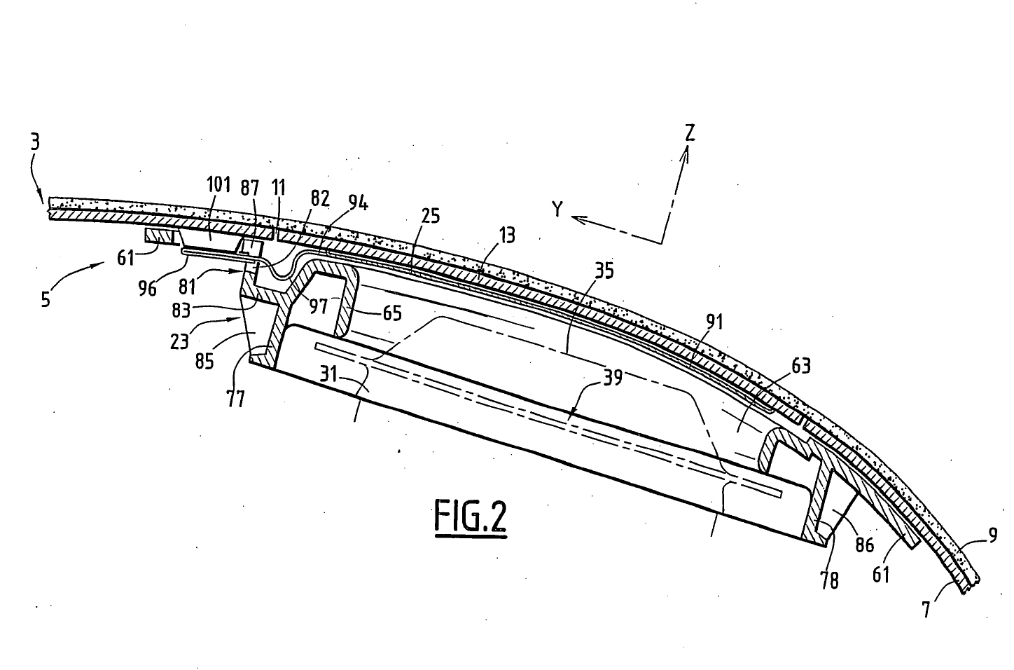

FIG. 2 is a section view on plane 2-2 and on a larger scale showing the FIG. 1 part in an assembled configuration;

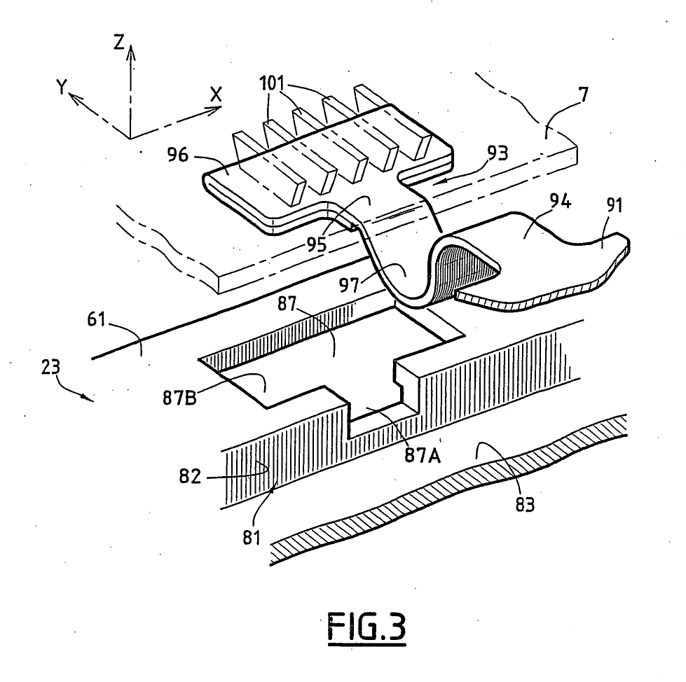

FIG. 3 is a perspective view of a detail of FIG. 1, showing the elements involved in making the connection between the reinforcing flap and the frame;

FIG. 4 is a fragmentary diagrammatic exploded view showing a dashboard assembly in a second aspect of the present invention;

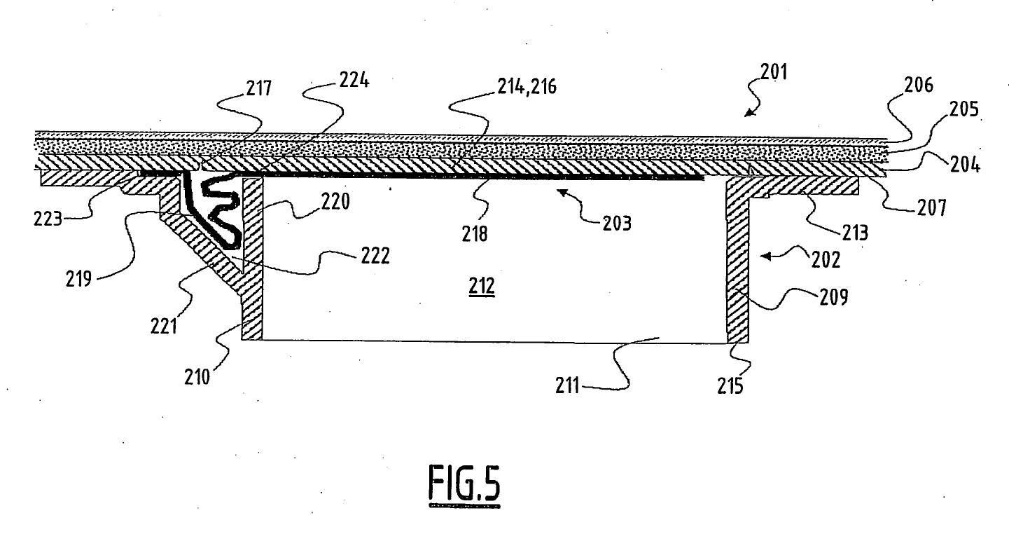

FIG. 5 is a diagrammatic section view of a dashboard assembly in the second aspect of the present invention;

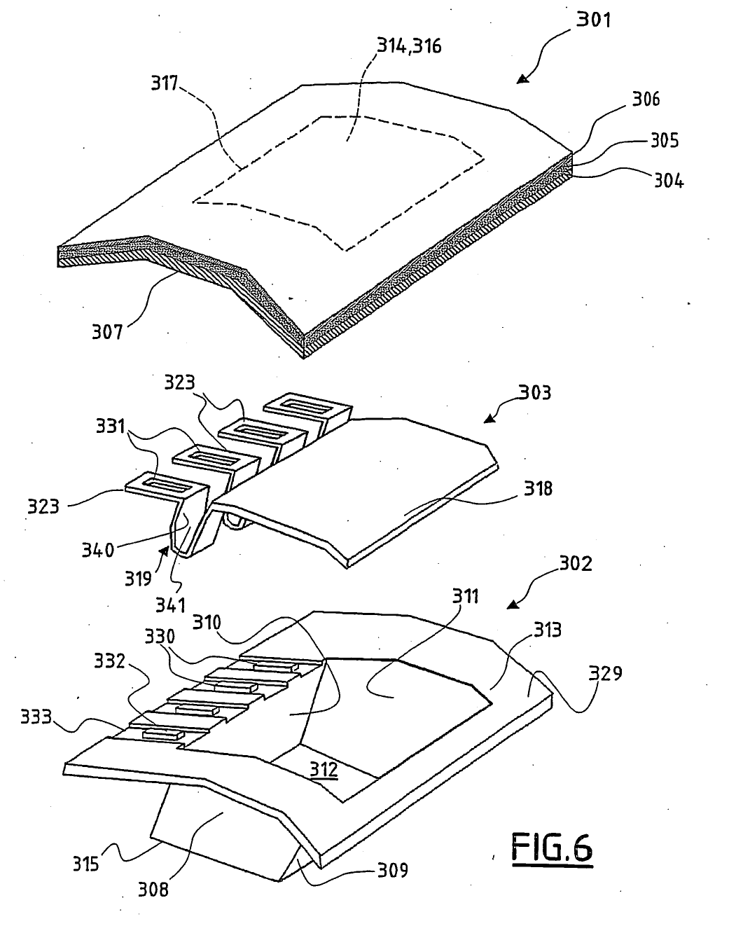

FIG. 6 is a fragmentary diagrammatic exploded perspective view of an interior part of a motor vehicle in accordance with the third aspect of the invention;

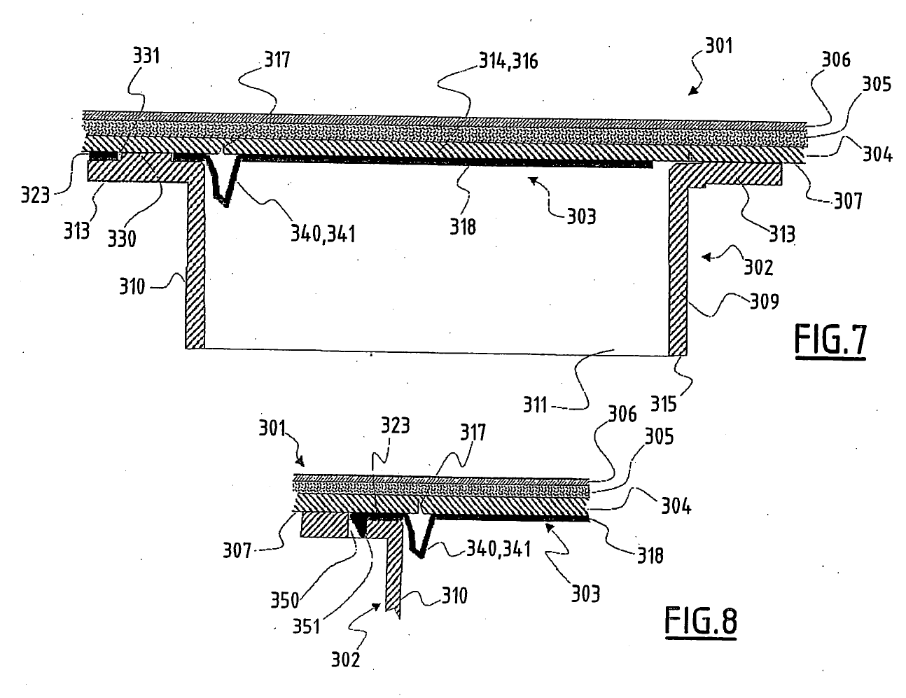

FIG. 7 is a diagrammatic section view of a part in an assembled configuration constituting a first embodiment of the third aspect; and

FIG. 8 is a diagrammatic section view of a part in the assembled configuration constituting a second embodiment of the invention in its third aspect.

FIGS. 1 to 3 show a motor vehicle part 1 which comprises a dashboard portion 3 and an airbag safety assembly 5.

In the example shown, the dashboard portion 3 is constituted by a portion of the dashboard facade on the passenger side, with the safety assembly 5 being of the type known as a “passenger airbag”. The dashboard portion 3 comprises a wall 7 of plastics material that is covered in the example shown by a layer 9 of covering trim. A line of weakness 11 is formed in the wall 7 defining a hatch 13 that is detachable from the wall 7 when the airbag assembly 5 inflates.

The safety assembly 5 essentially comprises an airbag device or “module” 21, an airbag deployment guide frame 23, and a reinforcing flap 25.

In FIG. 1 in particular, there can also be seen a crossbeam 27 forming a structural part of the vehicle and on which the module 21 is secured.

For clarity in the drawings, and for greater convenience in the description below, the figures are oriented in a system of orthogonal axes X, Y, Z that differs from the system of axes generally used for defining orientation in a vehicle, and in which:
the axis Z represents the main axis of airbag deployment that is directed substantially away from the dashboard portion towards the expected location of the head of a passenger for whom the safety device is intended;
the axis X is a transverse axis extending substantially horizontally, corresponding to a transverse axis of the vehicle, and in the figures it extends from the left towards the right of the vehicle; and
the axis Y is orthogonal to the two above-specified axes, extending essentially from the rear towards the front of the vehicle.

To simplify the description, the Z axis is assumed to be vertical even though it is in fact significantly inclined relative to the vertical, the XY plane consequently being assumed to be horizontal. All position and direction terms such as “up”, “down”, “top”, “bottom”, should be understood relative to this Z axis.

The term “axial” also relates to the Z axis, i.e. the main axis of airbag deployment.

Still with reference to FIGS. 1 to 3, the description below gives greater detail about the safety assembly 5.

The module 21 comprises an airbag (not shown in the figures), a housing 31 in which the airbag is housed, an inflation gas generator (not shown) likewise contained in the housing 31, and a tearable membrane 35 for temporarily closing the housing.

The housing 31 presents a bottom 37 such that the bottom portion of the housing 31 is closed, and an opening 39 on the top side of the housing, which opening is substantially rectangular in shape. The opening 39 lies substantially in the XY plane, and it is elongate along the X axis. The opening 39 thus defines two long sides and two short sides of the housing 31.

The housing 31 is also provided with a tab 41 at right angles for securing to a complementary tab 43 that it itself secured to the beam 27. The tab 41 is provided beside the bottom 37 of the housing, and is rigidly secured to the complementary tab 43, e.g. by means of a bolt 45.

Beside the opening 39, the housing 31 is formed with a rim 49 on each short side of the housing, each rim 49 being provided with two fastening holes 50 that are offset along the Y axis.

The frame 23 is essentially constituted by a peripheral rim 61 whose inside defines an airbag release opening 63 that is generally rectangular in shape corresponding substantially to the shape of the opening 39 in the housing, and an axial channel 65 of section matching that of the opening 163. In the example shown, the peripheral rim 61 is made out of plastics material integrally with the channel 65, but it would also be possible for the channel to be fitted to the peripheral rim 61 and rigidly secured thereto.

In the mounted position shown in FIG. 2, the housing 31 of the module 21 has its opening 39 opening out into the channel 65, which channel consequently extends between the module 21 and the airbag release opening 63.

The top face of the peripheral rim 61 is inscribed in a slightly bulging surface that is almost plane and substantially horizontal, corresponding to the peripheral region of the line of weakness 11 in the bottom face of the dashboard wall 7. The top face of the peripheral rim 61 is secured to said region of the dashboard wall 7, preferably by heat-sealing.

The frame 23 is also formed to have two projecting strips forming lugs 71, on either side and shorter than the peripheral rim 61, with which they are formed integrally. Each of these lugs 71 comprises a substantially horizontal face having two fastening holes 73 formed therein to match the holes 50. The lugs 71 are rigidly secured to the rims 49, each by means of a bolt extending substantially along the Z axis, passing through the respective holes 50 and 73 and engaged in a nut.

Thus, the housing 31 is secured to the frame 23 by screw fasteners on two opposite sides of the peripheral rim 61. Nevertheless, in other embodiments, the housing could be connected directly to the frame in some other region, or need not be connected thereto at all.

In addition, the frame 23 has two opposite walls 77 and 78 that project downwards from the peripheral rim 61, forming linings that are substantially parallel or slightly inclined relative to the walls of the channel 65 situated on the long sides. The walls 77 and 78 extend outside from the corresponding walls of the channel 65 over a height that is greater, such that they extend to a lower level along the axis Z.

As can be seen in FIG. 2, one of the walls forming a lining, the wall 77, is connected to the peripheral rim 61 via a step 81. The step is formed by a substantially vertical wall 82 adjacent to the rim 61, and by a horizontal wall 83 adjacent both to the vertical wall 82 and to the wall 77.

It should be observed that stiffening ribs at right angles 85 interconnect the walls 77 and 83. Similarly, analogous ribs at right angles 86 interconnect the rim 61 and the wall 78.

As also shown in the figures, the frame 23 is provided on one of its long sides with windows 87, in this example two windows, disposed symmetrically about a vertical midplane YZ. Each window 87 is generally T-shaped, being cut out in the horizontal rim 61 and the vertical wall 82: as can be seen in particular in FIG. 3, the central limb 87A of the T-shape is cut out in part vertically in the wall 82 and in part horizontally in the rim 61, the parts being continuous relative to each other, while the top limb 87B of the T-shape extends horizontally along the X axis in the rim 61 only.

The flap 25 comprises both a metal plate 91 of shape and dimensions that match substantially the shape and dimensions of the release opening 63 and of the hatch 13, and retaining pieces 93 that are formed integrally with the plate 91.

The metal plate 91 is secured to the bottom face of the hatch 13 of the dashboard portion 3, e.g. by heat sealing.

The retaining portions 93 which are designed to co-operate with the windows 87 in the frame 23 are likewise two in number in the example shown, and are disposed in corresponding manner on the same side of the flap 25.

Each retaining portion 93 comprises a strip or strap 94 which projects laterally along the Y axis, from one of the long sides of the plate 91, together with a hook 95 secured to the free end of the strip 94. In the example shown, the hook 95 is made integrally out of the same piece of metal as the strip 94 and the plate 91.

The shape of the hook 95 matches the shape of the corresponding window 87. Thus, starting from the strip 94 which extends laterally along the Y axis, the hook 95 presents a transversely elongate bar 96 at the free end of the strip 94 extending transversely along the X axis and designed to engage in the portion 87B of the window 87 by being inserted along the Z axis.

At the bar 96, the hook 95 is stiffened by folding an end, so that the bar 95 is twice the thickness of the strip 94.

The width of the strip 94 is designed so that it can slide freely in the vertical direction Z inside the portion 87A of the window 87.

It will be understood that by co-operating with the portions of the wall 82 adjacent to the window 87, the bar 96 prevents the hook 95 from being withdrawn from the window 87. The vertical wall 82 thus defines a complementary shoulder for the hook 95.

The window portion 87B is referred to as the “insertion portion” for the hook 95, while the window portion 87A is described as the “retaining portion” for said hook.

It should be observed that the strip 94 presents an undulation 97 serving to enable the strip to be stretched when a traction force is applied thereto. Such a force occurs when the safety device is triggered. By stretching, the strip 94 allows the hatch 13 to become completely detached from the remainder of the dashboard portion 3 and to be ejected while continuing to be held thereto.

As shown in FIGS. 2 and 3, the bottom face of the dashboard wall 7 is formed with ribs 101 that engage in the insertion portion 87B in order to hold the hook 95 therein. After the hook 95 has been engaged in the window 87, the bar 96 can no longer be extracted from the window 87 because the window is closed at least in part by the ribs 101.

These ribs 101 are formed as vertical YZ tongues each extending essentially over the entire Y width of the insertion portion 87B of the window and essentially over the entire Z thickness of the rim 61. In the example shown (FIG. 3), there are five ribs 101 distributed along the X axis over substantially the entire length of the insertion portion 87B.

It will be understood that when the device is triggered, starting from the assembled configuration shown in FIG. 2, inflation of the airbag causes the membrane 35 to tear and then the flap 25 to open under the impact of the airbag, and to pivot about the retaining portions (or hinges) 93. The hatch 13 then becomes detached from the remainder of the dashboard portion 3, being cut apart via the lines of weakness 11. The hinges 93 stretch at the same time as the hatch 13 is being ejected from the surface of the dashboard. Because the hooks 95 are held in the windows 87, the hinges 93 retain the metal plate 91, and the hatch 13 secured thereto in connection with the frame 23. This avoids ejecting fragments of the dashboard towards the passenger.

There follows a brief description of a method of assembling the part 1 as described above, in a preferred implementation of the invention.

Initially, the flap 25 is secured to the corresponding face of the hatch 13 by heat sealing the top face of the metal plate 91 to the bottom face of the hatch 13.

The hooks 95 are then free, poking out, and ready to be engaged.

In a second step of the method, the frame 23 is presented under the dashboard portion 3 in order to be secured thereto. On approaching the wall 7, the hooks 95 are engaged in the respective windows 87, insertion taking place substantially “flat”, through the insertion portion 87B and essentially along the Z axis. This means that while the bar 96 is being engaged in the window 87, it is held in a plane that is substantially parallel to the surface of the rim 61.

Simultaneously, the ribs 101 engage in the insertion portions 87B and prevent the bars 96 from being extracted via the insertion portions 87B.

In a following step of the method, the frame 23 is held in contact with the wall 7 and is secured thereto, e.g. by heat-sealing the rim 61 to the bottom face of the wall 7.

In a following assembly step, the airbag module 21 is mounted relative to the previously-obtained assembly, and specifically it is mounted relative to the frame 23. In particular, the tabs 41 and 43 are held together by bolts 45, and in the example shown, the rims 49 of the airbag module are secured to the lugs 71 of the frame, by screw fasteners or by riveting.

As mentioned above, in other embodiments of the invention, it is possible to omit such direct fastening of the housing 31 to the frame 23, or possibly to perform such fastening at other locations and/or by other means.

The invention described above provides a connection between the flap and the frame that is very simple and very reliable, and it enables the part to be assembled by operations that are relatively quick, and that require less tooling than in the assembly methods of the prior art.

Reference is now made to FIGS. 4 and 5.

The dashboard assembly in this aspect of the invention enables an airbag safety device (not shown) to be mounted so as to be invisible from inside the cabin and so as to protect the passenger of the vehicle in the event of the vehicle suffering a major impact, by the airbag being deployed by being inflated.

This type of dashboard assembly comprises at least one dashboard portion 201 provided with a gate zone 216 presenting a peripheral line of weakness 217 located in the inside face 207 of the dashboard portion so as to be invisible from inside the vehicle cabin.

This gate zone 216 defines an opening zone 214 through which the airbag of the safety device deploys into the cabin in the event of the airbag safety device being triggered.

This dashboard portion 201 includes a dashboard insert 204 of self-supporting rigid plastics material.

In one embodiment, this insert 204 presents a decorative face on its side opposite from the inside face 207. In a more developed embodiment, the face of the insert 204 opposite from its inside face 207 is covered in a layer of foam 205 that is in turn covered in a trim-forming skin 206.

On the inside face 207 of the dashboard portion 201 there is provided a guide element 202 for guiding deployment of the airbag. The guide element 202 serves to channel the direction in which the airbag travels while it is being deployed.

The guide element 202 has walls 208, 209, 210, and 211 forming a guide channel 212 for surrounding the airbag safety device at least in part, and a peripheral rim 213 for securing to the inside face 207 of the dashboard portion 201 surrounding the opening zone 214 in the dashboard portion 201.

In an embodiment that is not shown, at least some of the free edges 215 of the walls 208, 209, 210, 211 of the guide element 202 have fastener means for co-operating with complementary fastener means of the airbag safety device.

In order to reinforce the gate zone 216, it is provided on the inside face 207 with at least one reinforcing flap 218 fitted thereto. The reinforcing flap 218 may be secured to the inside face of the gate zone 216 by any known means. By way of non-limiting example, mention can be made of vibration welding and plastic deformation. For a single gate having a U-shaped opening, there is only one reinforcing flap 218, and for a pair of gates with an H-shaped opening, there are two reinforcing flaps. To simplify the description below, reference is made to a single gate having a U-shaped opening, but that does not exclude the possibility of using a pair of gates with an H-shaped opening.

A hinge element 219 connects the reinforcing flap 218 to the guide element 202 and/or to the insert 204. The hinge element 219 presents an operative fastening zone 223 opposite from the reinforcing flap 218, said operative fastening zone 223 being secured to the fastening peripheral rim 213 of the guide element 202 and/or to the insert 204. While the airbag is deploying, it is the hinge element 219 that enables the gate zone 216 and the associated reinforcing flap 218 to disengage from the dashboard portion 201 and to pivot so as to open the opening zone 214 and allow the airbag to deploy into the vehicle cabin.

In the invention, the guide element 202 includes a hinge shield 220 enabling the hinge element 219 to be isolated from the guide channel 212.

In the embodiment shown in the figures, the hinge shield 220 is constituted by one of the walls 208, 209, 210, and 211 of the guide element 202, specifically the wall 210, with the hinge element 219 being located behind the shield 220 relative to the guide channel 212.

The wall 210 constitutes a double wall 220, 221 facing the hinge element 219 and defining a cavity 222 surrounding said hinge element 219. The double wall comprises a first wall forming the shield 220 and providing continuity to the guide channel 212 as far as the reinforcing flap 218, and a second wall 221 that is connected to the peripheral fastening rim 213.

In conventional manner, the peripheral line of weakness 217 is at least partially in register with the peripheral fastening rim 213, however in order to improve the deployment of the hinge element 212 and the pivoting of the gate zone 216 and the associated reinforcing flap 218:
the reinforcing flap 218 is secured to the gate zone 216 as far as into the cavity 222; and/or
portion of the peripheral line of weakness 217 is located in register with the cavity 222.

The hinge element 219 and the reinforcing flap 218 are made together by injection-molding plastics material.

Alternatively, the hinge element 219 and the reinforcing flap 218 can be formed together by stamping a metal sheet.

Alternatively, the hinge element 219 may be a strip having a reinforcing flap of plastics material molded thereon (not shown).

In the embodiment shown in the figures, the guide element is molded as a single piece with the walls 208, 209, 210, 211 forming the guide channel 212 and with the peripheral fastening rim 213.

The operative fastening zone 223 is assembled to the peripheral fastening rim 213 of the guide element 202 and/or to the insert 204 by any known means. By way of example, mention can be made of vibration welding or of plastic deformation, or indeed of the method of assembly described in FR 0 314 676.

The dashboard assembly described by way of illustration is of the type having a U-shaped opening. It should be clearly understood that the present invention also covers dashboard assemblies of the type having an H-shaped opening. With an H-shaped opening, there are two hinge elements for protecting by respective hinge shields, as described above.

FIGS. 6 to 8 show a motor vehicle part enabling an airbag safety device (not shown) to be mounted so as to be invisible from inside the cabin, but nevertheless serving to protect the vehicle passenger by deploying the airbag in the event of said vehicle being subjected to a large impact. This type of part comprises a dashboard portion 301 having a hatch 316 presenting a peripheral line of weakness 317 located in the inside face 307 of the dashboard portion 301 so as to be invisible from inside the vehicle cabin. The hatch 316 defines an opening zone 314 through which the airbag of the safety device deploys into the cabin in the event of the airbag safety device being triggered.

This dashboard portion 301 comprises a dashboard insert 304 of self-supporting rigid plastics material.

In an embodiment not shown, this insert 304 presents a decorative face opposite from its inside face 307. In a more developed embodiment, as shown in the figures, the face of the insert 304 opposite from its inside face 307 is covered in a layer of foam 305 which is itself covered by a trim-forming skin 306.

A frame 302 is assembled to the inside face 307 of the dashboard portion 301 to form a guide channel 312 for guiding deployment of the airbag.

The frame 302 comprises walls 308, 309, 310, 311 forming the guide channel 312 and designed to surround the airbag safety device at least in part, and a peripheral rim 313 for fastening to the inside face 307 of the dashboard portion 301 and surrounding the opening zone 314 of the dashboard portion 301.

In an embodiment that is not shown, at least some of the free edges 315 of the walls 308, 309, 310, and 311 of the guide element 302 include fastener means for co-operating with complementary fastening means of the airbag safety device.

In order to reinforce the gate zone 316, it has a reinforcing flap 303 fitted to its inside face 307. The reinforcing flap 303 comprises a reinforcing plate 318 fitted to the inside face of the hatch 316 by any known means. By way of non-limiting example, mention can be made of vibration welding and of plastic deformation. When there is a single hatch for a U-shaped opening, there is only one reinforcing flap 303, and when there are two hatches for an H-shaped opening, there are two reinforcing flaps. To simplify the description below, reference is made to a single hatch for a U-shaped opening, but that does not exclude there being two hatches for an H-shaped opening.

The reinforcing flap 303 further includes a hinge element 319 connecting the reinforcing plate 318 to the frame 302 and/or to the insert 304. The hinge element 319 presents an operative assembly zone 323 remote from the plate 318, said operative assembly zone 323 being associated with the frame 302 and/or with the insert 304.

In the invention, the operative assembly zone 323 co-operates with a complementary shoulder 330, 350 formed together with the frame 302 and/or the insert 304 in such a manner that on deployment of the airbag, the hinge element 319 acts against the hatch 316 being ejected together with the associated reinforcing plate 318, and enables the hatch 316 and the associated reinforcing plate 318 to separate from the dashboard portion 301 and to pivot so as to open the opening zone 314 and allow the airbag to deploy into the vehicle cabin, while remaining connected to the dashboard portion 301.

In a first embodiment shown in FIGS. 6 and 7, the shoulder 330, 350 is defined by a rib 330 formed to project from the frame 302, and the operative assembly zone of the hinge element is provided with at least one opening 331 through which the rib 330 passes, the rib 330 presenting a free end 332 that comes into contact with the dashboard portion 301 in such a manner as to hold the rib 330 engaged in the opening 331 of the operative assembly zone 323 at the interface between the frame 302 and the dashboard portion 301.

In particular, the frame 302 presents a rim 313 for fastening to the dashboard portion 301, the rim having a face 329 that is pressed against and secured to a complementary face of the dashboard portion 301. The rib 330 is localized in a setback zone 333 of the face 329 that is pressed against and secured to the complementary face of the dashboard portion 301 in such a manner that the free end 332 of the rib 331 is flush with and lies in the plane of the adjacent region of the face 329, which face 329 is pressed against and secured to a complementary face of the dashboard portion 301. Advantageously, in order to compensate for manufacturing and assembling clearances, the opening 331 presents dimensions that are slightly greater than those of the rib 330 that it is to receive. Similarly, the setback zone 333 presents dimensions that are slightly greater than those of the operative assembly zone 323 that it is to receive.

In an alternative that is not shown, the ribs are carried by the dashboard portion 301.

In another embodiment shown in FIG. 8, the shoulder 330, 350 is defined by a passage 350 formed in the frame 302, and the operative assembly zone 323 of the hinge element 319 is provided with at least one catch 351 directed away from the dashboard portion 301 and passing through the passage 350.

In particular, the frame 302 presents a rim 313 for fastening to the dashboard portion 301, the rim having a face that is pressed against and secured to a complementary face of the dashboard portion 301, and the passages 350 are localized in setback zones of the face that is pressed against and secured to the complementary face of the dashboard portion 301 in such a manner that the catches 351 are held in position in the passages 350 by the overlying dashboard portion 301.

As shown in FIG. 6, and as is applicable in any embodiment, the hinge element 319 preferably comprises at least one strip 340 made integrally with the reinforcing plate 318 on one of the edges thereof, with an operative assembly zone 323 being formed beside the free end of said strip 340.

The strip 340 presents an undulation 341 such that said strip 340 can be stretched, thus enabling the hatch 316 to become completely detached and to be ejected from the dashboard portion 301 when the device is triggered.

The reinforcing flap 303 has at least two such strips 340 arranged symmetrically from an edge of the reinforcing plate 318, each being formed with a respective operative assembly zone 323.

There follows a brief description of the method of assembling the part as described above, in a preferred implementation of the invention.

Initially, the flap 303 is secured to the corresponding face of the hatch 316 by heat-sealing the top face of the reinforcing plate 318 to the bottom face 307 of the dashboard portion 301 facing the hatch 316.

The operative assembly zones 323 are then free and ready for assembly.

In a second step of the method, the frame 302 is presented to the bottom face 307 of the dashboard portion 301 in order to be secured thereto. On approaching the face 307, the operative assembly zones are made to co-operate with the complementary shoulders.

In a following step of the method, the frame 303 is held in contact with the wall 307, and is secured thereto, e.g. by heat-sealing the rim 313 to the bottom face 307.

The invention as described above provides a connection between the flap and the frame that is very simple and also very reliable, enabling the part to be assembled by operations that are relatively quick, and that require less tooling than in the assembly methods of the prior art.

The dashboard part described by way of illustration is of the type having a U-shaped opening. Naturally, the present invention also covers dashboard parts of the type having an H-type opening. With an H-opening, there are two distinct hinge elements on either side of the opening 314, each hinge element co-operating with a complementary shoulder as described above.

1-27. (canceled)

28. A motor vehicle part comprising:
an airbag safety device comprising a housing and an airbag contained in said housing;
a dashboard portion formed with an extraction hatch adapted to open under the effect of the airbag inflating when the device is triggered;
a frame secured to the dashboard portion; and
a flap for reinforcing the hatch, a portion of the flap being pressed against a face of the hatch and being secured thereto, and in which a retaining portion is secured to the frame via at least one retaining hook acting against the flap being ejected in the event of the device being triggered;
in which said hook is formed integrally with the flap and, during triggering of the device, co-operates with a complementary shoulder formed with the frame;
wherein the frame is arranged between the housing and the hatch in such a manner as to form a guide channel for guiding deployment of the airbag, and wherein said shoulder is defined by a window formed in the frame, and the dashboard portion presents at least one rib that projects into the window so as to close the window at least in part and hold the hook engaged in said window.

29. A part according to claim 28, wherein the hook is T-shaped, the window being of corresponding shape.

30. A part according to claim 28, wherein the frame presents a rim for fastening to the dashboard portion, the rim having both a face pressed against and secured to a complementary face of the dashboard portion, and also an adjacent wall that is substantially orthogonal thereto, and wherein each window comprises a respective insertion portion for inserting the hook formed in said rim, and a retaining portion forming a shoulder for the hook that is formed in said adjacent wall, the insertion portion being closed at least in part by the respective ribs of the dashboard portion.

31. A part according to claim 28, wherein the flap comprises a plate of shape complementary to the hatch and secured thereto, and wherein the retaining portion comprises at least one strip formed integrally with said plate from an edge thereof, with said hook being formed beside the free end of said strip.

32. A part according to claim 31, wherein the strip presents an undulation such that said strip can be stretched, thus enabling the hatch to become completely detached and to be ejected from the dashboard portion on triggering of the device.

33. A part according to claim 31, wherein the flap has at least two such strips disposed symmetrically from an edge of the plate, and each formed with a hook.

34. A method of assembling a part according to claim 28, in which the shoulder is defined by a window formed in the frame, in which method, the following steps are performed in succession:
fixing the flap to the corresponding face of the hatch;
presenting the frame for fastening to the dashboard portion, and engaging the hooks in the respective windows; and
fastening the frame to the dashboard portion.

35. A method according to claim 34, wherein the safety device is subsequently fastened relative to the frame.

36. A method according to claim 34, wherein the flap is fastened to the hatch by heat-sealing.

37. A method according to claim 34, wherein the frame is fastened to the dashboard portion by heat-sealing.

38. A motor vehicle dashboard assembly comprising:
a dashboard portion having an inside face provided with a peripheral line of weakness defining a gate zone;
a guide element for guiding deployment of the airbag of an airbag safety device, said guide element being secured to the inside face of the dashboard portion and comprising:
walls forming a guide channel designed to surround the airbag safety device at least in part; and
a peripheral rim for fastening the guide element to the inside face of the dashboard portion around the gate zone, and internally defining an opening zone of the dashboard portion for passing the airbag;
at least one reinforcing flap secured to the inside face of the dashboard portion in register with the gate zone; and
a hinge element connecting the reinforcing flap to the guide element and/or to the dashboard portion;
wherein the guide element includes a hinge shield isolating the hinge element from the guide channel.

39. A dashboard assembly according to claim 38, wherein the walls forming the guide channel and the peripheral fastening rim are made together by injection-molding plastics material.

40. A dashboard assembly according to claim 38, wherein the wall of the guide element facing the hinge element forms a double wall defining a cavity surrounding said hinge element, the double wall comprising a first wall forming the shield and providing continuity for the guide channel as far as the reinforcing flap, and a second wall that is connected to the peripheral fastening rim.

41. A dashboard assembly according to claim 38, wherein the hinge element and the reinforcing flap are made together by injection-molding plastics material.

42. A dashboard assembly according to claim 38, wherein the hinge element and the reinforcing flap are formed together by stamping a metal sheet.

43. A dashboard assembly according to claim 38, wherein the hinge element presents an operative fastening zone opposite from the reinforcing flap, said operative fastening zone being assembled to the peripheral fastening rim of the guide element and/or to the dashboard portion.

44. A motor vehicle part comprising:
a dashboard portion formed with an extraction hatch adapted to open under the effect of inflation of the airbag of an airbag safety device, in the event of the device triggering;
a frame secured to the dashboard portion, and forming a guide channel for guiding the deployment of the airbag; and
a reinforcing flap for reinforcing the hatch, having a reinforcing plate pressed against a face of the hatch and secured thereto, and having a hinge element connected to the frame and/or to the dashboard portion via at least one operative assembly zone acting against ejection of the flap during triggering of the device;
wherein the operative assembly zone is formed integrally with the hinge element and with the reinforcing plate, and during triggering of the device co-operates with a complementary shoulder formed with the frame or with the dashboard portion.

45. A part according to claim 44, wherein said shoulder is defined by a rib formed projecting from the frame or from the dashboard portion, and the operative assembly zone of the hinge element is provided with at least one opening through which the rib passes, the rib presenting a free end coming into contact respectively with the dashboard portion or the frame so as to hold the rib engaged in the opening of the operative assembly zone at the interface between the frame and the dashboard portion.

46. A part according to claim 45, wherein the frame presents a rim for fastening to the dashboard portion, the frame having a face pressed against and secured to a complementary face of the dashboard portion, and wherein the ribs are localized in setback zones of the face that is pressed against and secured to the complementary face of the dashboard portion, in such a manner that the free ends of the ribs lie in the plane of the face that is pressed against and secured to a complementary face of the dashboard portion.

47. A part according to claim 44, wherein said shoulder is defined by a passage formed through the frame, and the operative assembly zone of the hinge element is provided with at least one catch directed away from the dashboard portion and passing through the passage.

48. A part according to claim 47, wherein the frame presents a rim for fastening to the dashboard portion, the rim having a face pressed against and fastened to a complementary face of the dashboard portion, and wherein the passages are localized in setback zones of the face pressed against and fastened to the complementary face of the dashboard portion in such a manner that the catches are held in position in the passages by the overlying dashboard portion.

49. A part according to claim 44, wherein the hinge element comprises at least one strip formed integrally with said plate from an edge thereof, an operative assembly zone being formed beside the free edge of said strip.

50. A part according to claim 49, wherein the strip presents an undulation such that said strip can be stretched, thus enabling the hatch to become complementary detached and ejected from the dashboard portion during triggering of the device.

51. A part according to claim 49, wherein the flap comprises at least two such strips arranged symmetrically from an edge of the plate, and each formed with a respective operative assembly zone.

52. A method of assembling a part according to claim 44, in which the following steps are performed in succession:
fastening the flap to the corresponding face of the hatch;
presenting the frame for fastening to the dashboard portion, and causing the operative zones to co-operate with the respective complementary shoulders; and
fastening the frame to the dashboard portion.

53. A method according to claim 51, wherein the flap is fastened to the hatch by heat-sealing.

54. A method according to claim 52, wherein the frame is fastened to the dashboard portion by heat-sealing.
